(19) United States
(12) Patent Application Publication
(10) Pub. No.: US 2001/0026156 A1
(43) Pub. Date: Oct. 4, 2001

(54) Method of determining the resistivity of a formation around a cased well

(76) Inventors: Isabelle Dubourg, Chilly Mazarin (FR); Olivier Faivre, Paris (FR)

Correspondence Address: Intellectual Property Law Department, Schlumberger-Doll Research, Old Quarry Road, Ridgefield, CT, 06877-4108, US

(21) Appl. No.: 09/815,503

(22) Filed: Mar. 23, 2001

Related U.S. Application Data
(60) Provisional application No. 60/192,759, filed on Mar. 28, 2000.

(51) Int. Cl. G01V 3/00

(52) U.S. Cl. 324/312

(57) ABSTRACT

The invention relates to a method of studying a geological formation through which a cased borehole passes, in which current is injected into casing and current leakage is measured indicative of the resistivity of the formation, the method being characterized in that the resistivity is corrected by a factor which takes account of the thickness of the layer of cement and of its conductivity.

The invention relates to determining the resistivity of geological formations around a well that is provided with metal casing.

To decide whether to put an oil well into production, it is common practice to measure the resistivity of the formations through which it passes, where resistivity is a fundamental value for calculating saturation in fluid (essentially water or liquid and gaseous hydrocarbons), i.e. the ratio of volume occupied by fluid over the total volume of the pores in the rock. The resistivity of a formation depends essentially on the fluid it contains. A formation containing salt water which is conductive has much lower resistivity than a formation filled with hydrocarbons.

Such measurements are taken essentially by means of tools comprising current electrodes for delivering electric current, focusing electrodes for obliging the current to penetrate into the formation along parallel lines of force, and measurement electrodes for which the potential of an electrode is proportional to the apparent resistivity of the ground. These measurements are practically the only measurements that give information over a significant depth of investigation.

For tens of years, the field of application of such measurements has been limited to so-called “open holes”, i.e. wells that are not cased. The presence in the well of metal casing having resistivity that is tiny compared with the values that are typical for geological formations (about 2.10⁻⁷ ohm.m for steel casing compared with 1 ohm.m to 1000 ohm.m for a formation), constitutes a considerable barrier to delivering electric currents into the formations surrounding the casing.

Although the principles of measuring resistivity in cased wells have been described for more than fifty years, it is only very recently that the first data has been published from the field. Measurement is based on causing current to flow along the casing under conditions causing current loss or leakage to occur into the formation. This loss is a function of the resistivity of the formation, and it increases with increasing conductivity of the formation, so by measuring it, it is possible to determine the resistivity of the formation. Current loss can be evaluated by measuring voltage drop between electrodes placed at different depths in the well.

The principles of such measurement are described in the literature, and in particular in the following patents: U.S. Pat. No. 2,459,196, U.S. Pat. No. 2,729,894, FR-2,207,278, U.S. Pat. No. 4,796,186, and U.S. Pat. No. 4,820,989. More recent proposals seeking in particular to avoid the need to use a reference electrode has been made in patent U.S. Pat. No. 5,510,712 which provides for applying currents to the casing at two locations that are spaced apart in the longitudinal direction, and patent U.S. Pat. No. 5,543,715 which proposes an additional current electrode.

International patent application WO 00/67047 relates to a technique of compensating for non-uniformities in the resistance of the casing due in particular to deposits of rust and the like, which method consists, in a first step, in injecting current into the casing at a first point that is longitudinally spaced apart from said formation so as to cause current to leak into said formation, and in using electrodes that define two consecutive sections of casing situated level with said formation to measure respective potential drops along said sections. In a second step, current is injected into the casing so as to create current leakage towards the formation at a second point that is spaced apart longitudinally from the formation on its side opposite from the first point, and said electrodes are used to measure the potential drop along said section, after which corresponding measurements in the two steps are combined so as to obtain values corresponding to a circuit formed by the casing between the two injection points and essentially free from leakage towards the formation, and the current leakage is then determined which is indicative of the resistivity of the formation on the basis of the measurement made in the first or the second step, and also on the basis of the values that result from said combination.

Finally, international patent application WO 00/65380 proposes means for determining the potential of the casing by calculation on the basis of the leakage current by applying a factor which depends on the distance z between said level and the surface.

Another difficulty encountered with that type of measurement is associated with the presence of a layer of cement between the formation and the casing. Depending on circumstances, the cement layer can have conductivity which is greater than or less than the conductivity of the adjacent formations, and it opposes injection of current into the formation. The cement factor is all the more critical in that the cement is behind the casing and there can therefore be no question of measuring its resistance directly. In “Electrical resistivity measurement through metal casing”, Clifford J. Schenkel and H. Frank Morrison, GEOPHYSICS, Vol 59, No. 7 (July 1994); pp 1072-1082, considers the effect of cement and annular invasion on the cased hole resistivity measurement. However, the values used for the cement thickness in this study are unrealistic and the conclusion presented is that the effect of cement is not expected to be very important.

The cement effect is usually avoided merely by calibration by comparing the apparent resistivity of a zone of impermeable formation of known resistivity as measured in a cased well with its effective resistivity as measured in an open hole.

Nevertheless, such measurement is not always possible, in particular open-hole measurements are not always made or are not easily available. Furthermore, the effect that the cement layer exerts on the apparent resistivity depends, in fact, on the effective resistivity of the formation layers. It would therefore be desirable to be able to quantify this cement effect, and to do in a manner that is relatively simple and robust so that the effect can easily be integrated in interpreting measurement data.

An object of the present invention is thus to provide simple means for correcting the cement effect in resistivity measurements in a cased well.

Investigations have shown that the effect of the layer of cement depends in particular on the thickness of the layer of cement; on the resistivity of the layer of cement; on the distance to the casing shoe; on the resistivity of the formation bed level with the measurement zone and of the surrounding beds, etc. Under such conditions, the number of parameters would appear to be much too large to allow any simple resolution compatible with ordinary computation and analysis times.

The present inventors have found that many of these parameters can advantageously be ignored so that the problem can be simplified to a very great extent with account being taken in practice only of the thickness of the layer of cement and of its conductivity. This makes it possible to propose simplified correction curves which, for various thicknesses of the layer of cement, propose a correction coefficient equal to the ratio between the “true” resistivity Rt of the formation bed level with the measurement zone and the measured resistivity Rm as a function of the ratio between the measured resistivity and the resistivity of the cement.

It thus turns out that the problem can be treated, at least to a first approximation, merely in linear manner, without taking account of factors such as the thickness of the bed level with the measurement zone, the size of the casing, or the distance to the cementing shoe, or in other words to the end of the cemented zone.

The invention thus provides means for performing measurements in a well that is producing from the deposit, enabling water-hydrocarbon interfaces to be located, and thus making it possible to track the way the positions of such interfaces vary over time in order to monitor the behavior of the hydrocarbon well and optimize working thereof. It is also possible to obtain a resistivity measurement in a well (or in a section of a well) where no measurements were taken before the casing was installed, specifically in order to improve knowledge about the reservoir, and possibly also to detect any productive layers that were not located initially.

One aspect of the invention provides a method of determining the resistivity of a formation surrounding a borehole having a casing surrounded by a layer of cement located therebetween, comprising: (i) injecting a current into the casing; (ii) measuring current leaking from the casing into the formation; (iii) determining the thickness of the layer of cement; (iv) determining the conductivity of the layer of cement; and (v) determining the resistivity of the formation using the measured current, the thickness of the cement, and the conductivity of the cement layer.

The thickness of cement can be determined using data relating to drilling of the borehole and to the casing located therein. The conductivity of the cement layer can be determined from data obtained when preparing the cement for placement in the borehole.

Preferably, a series of correction curves are determined for cement layers of different thicknesses, the correction curves relating the resistivity of the cement layer and the measured current; the resistivity of the formation being determined using the correction curve most appropriate for the thickness and conductivity of cement. The correction curves can comprise plots of the ratio of measured resistivity to cement resistivity vs. the ratio of true formation resistivity to measured resistivity for a series of cement thicknesses.

The resistivity of the formation is typically measured at a number of depths in the well.

Another aspect of the invention comprises a system for determining the resistivity of a formation surrounding a borehole having a casing surrounded by a layer of cement located therebetween, comprising: a tool that can be positioned in the casing and including electrodes for injecting a current into the casing, and electrodes for measuring current leaking from the casing into the formation; and an processing unit which determines the resistivity of the formation using the measured current, the thickness of the cement, and the conductivity of the cement layer.

The tool is usually capable of being logged through the borehole, for example on a wireline cable or the like, so as to make measurements at a number of depths in the casing. In such a case, the electrodes can be urged against the casing as the tool is logged through the borehole.

The invention will be well understood on reading the following description, given with reference to the accompanying drawings. In the drawings:

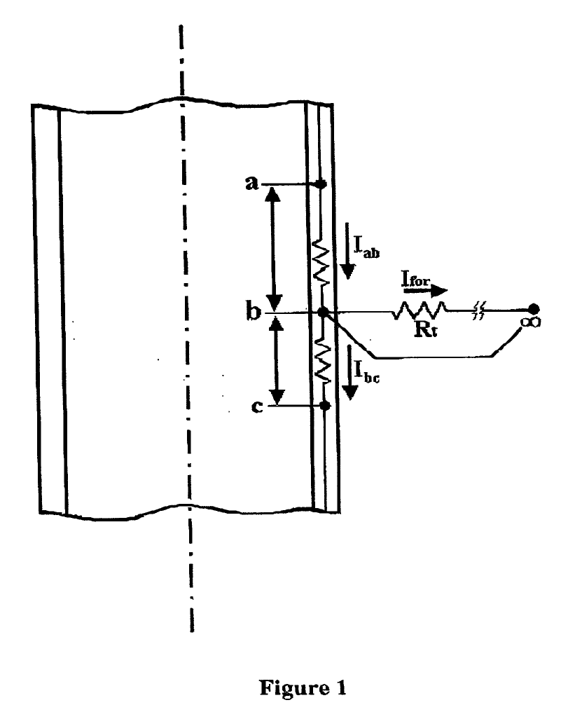

FIG. 1 recalls the principles on which resistivity is measured in a cased well;

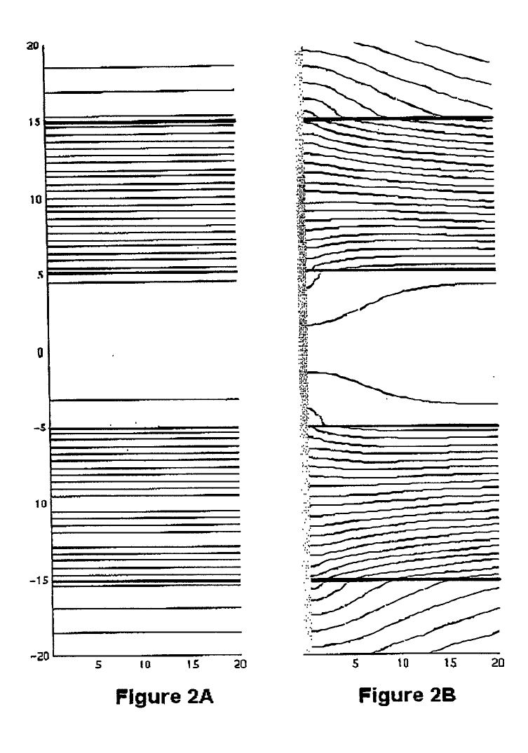

FIG. 2 is a diagram showing the effect of cement on lines of current;

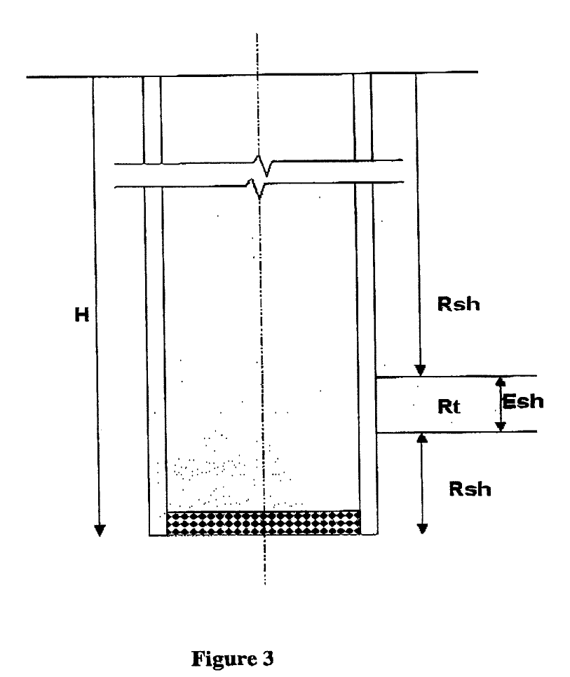

FIG. 3 is a theoretical diagram of the model of the well and the formation through which it passes as used for simulating the response of a tool for measuring resistivity in a cased well;

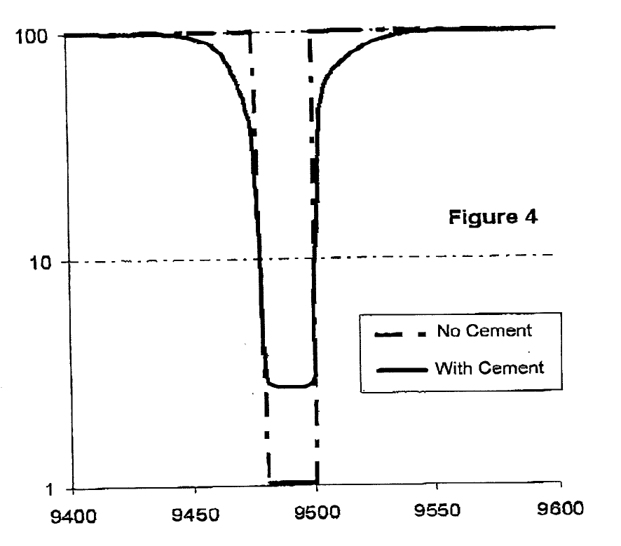

FIG. 4 shows the influence of cement on the measurement of the apparent resistivity of a formation;

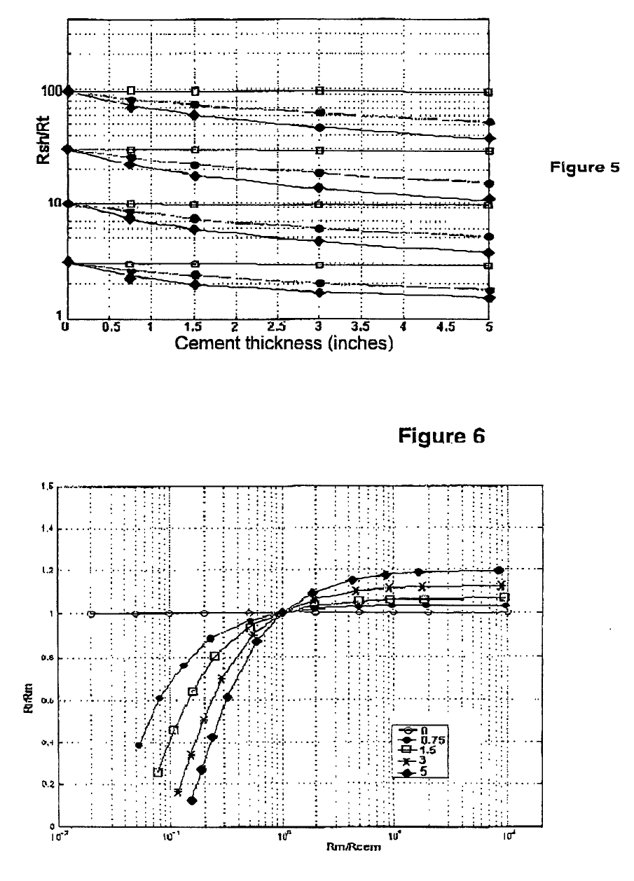

FIG. 5 gives an example of resistivity contrast curves between two adjacent beds as a function of the thickness of the layer of cement for different ratios between the resistivity of the cement and the resistivity of the central bed;

FIG. 6 gives an example of the correction curves obtained from curves of the kind shown in FIG. 5;

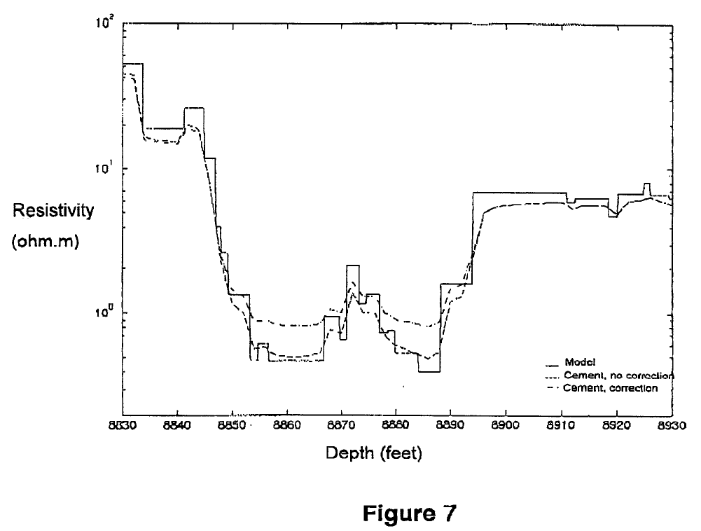

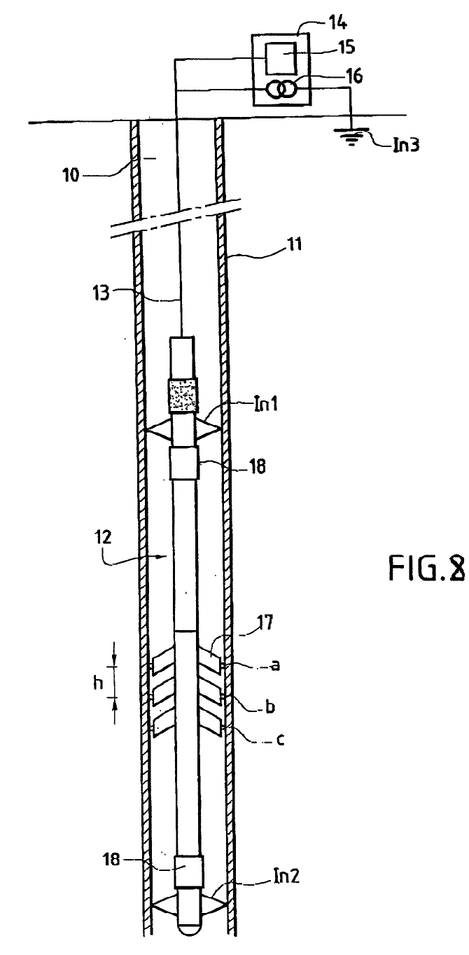

FIG. 7 is a comparative curve showing the response of the tool to a complex formation with or without correction for the cement effect; and

FIG. 8 diagramatically shows a system for implementing methods according to the invention.

Resistivity is measured in a cased well on the principles of causing current to flow along the casing with a return that is remote so as to enable current to leak into the geological formations through which the well passes, and of evaluating the leakage current: at any given level this current increases with increasing conductivity of the formation surrounding the well at this level. Mathematically, this is expressed in terms of an exponential decay law for current flowing in the casing, with the decay rate at a given level being a function of the ratio between the resistivity of the formation Rt and the resistivity of the casing Rc.

The diagram of FIG. 1 represents a section of a well 10 having an axis X-X′ and fitted with metal casing 11. The level (or depth) at which the measurement is to be performed is reference b. A section of casing (a,c) is investigated extending on either side of the level b. If current flows in the casing with a remote return (e.g. via the surface), then the loss of current into the formation is equivalent, in electric circuit terms, to a shunt resistor connecting level b of the casing to infinity. The resistance of this resistor is representative of the resistivity Rt of the formation at the level of electrode b. Using Ohm's law, it is thus possible to write:

Rt=k(Vb,∞/Ifor) [1]

where k is a constant, Vb, ∞ is the potential of the casing at level b relative to a reference at infinity, and Ifor is the leakage current at level b. Ifor can be determined, for example, by using the method described in patent application WO 00/67047.

That method comprises three steps. In a first step, current is injected into the casing at a first point that is spaced apart longitudinally from the formation so as to cause current to leak towards said formation, and the electrodes (a, b, c) defining two consecutive sections of casing situated level with the formation are used to measure the respective potential drops along said sections. In a second step, current is injected into the tubing so as to create a leak of current towards the formation, injection taking place at a second point that is spaced apart longitudinally from the formation and that is situated on the side opposite to the first point, and said electrodes are used to measure the potential drops along said sections. In a third step, corresponding measurements of the first two steps are combined so as to obtain values corresponding to a circuit formed by the casing between the two injection points and essentially free from any leakage towards the formation; the current leakage is then determined (which leakage is indicative of the resistivity of the formation) on the basis of the measurements performed in the first or the second step, and also on the basis of the values that result from said combination. In a preferred variant, the first injection point is situated above the formation and the second point is situated below it, and combination consists in subtracting the measurements of the second step from the measurements of the first step.

As a general rule, the factor k is estimated by assuming that it is a clearly geometrical constant which can be determined, e.g. by calibration, by taking measurements in an impermeable zone of the formation of resistivity that is already known, in particular because of open hole measurements performed before the well was put into operation, and by calculating the ratio between the apparent resistivity Vb, ∞/Ifor and the effective resistivity of the formation as measured before.

Nevertheless, situations arise in which no measurements taken prior to installing the casing are available for calibration purposes. Unfortunately, as mentioned above, resistivity measurements in cased wells must also make it possible to have a second 15 chance of investigating zones that have not been investigated. This can apply in particular to wells passing through zones that are very poorly consolidated or in which large losses of drilling mud occur that can be stopped only by installing casing and cementing the well immediately.

Furthermore, far from merely constituting a passive resistance, the cement will in fact amplify certain effects as shown in FIG. 2.

This figure is a diagram of lines of current flowing in a formation from the outside edge of casing, in the absence (FIG. 2A) or in the presence (FIG. 2B) of a layer of cement for a bed that presents very high resistivity and that lies between two beds of low resistivity, themselves in contact with beds of intermediate resistivity.

In the absence of cement, the metal casing acts as a perfect guard electrode and the lines of current are accurately radial. The presence of cement sets up a disturbance which causes the lines of current to migrate towards the more conductive beds.

The inventors have sought to quantify more precisely the influence of cement by considering a central bed of resistivity Rt between two shoulder beds of resistivity Rsh and by considering the following parameters:

the resistivity Rcem of the cement;

the thickness of the layer of cement;

the resistivity Rt of the central bed;

the contrast Rsh/Rt between the resistivity of the central bed and the resistivity of the surrounding (shoulder) beds; and

the thickness of the bed.

A well has thus been modelled as shown in FIG. 3 having a total depth H of 10,000 feet (3084 meters) passing through a relatively conductive “central” bed, of resistivity Rt and thickness Esh, lying between two non-conductive beds of resistivity Rsh. The total depth is equal to the depth from the surface down to the casing shoe. The well is fitted over its entire length with casing cemented by a thickness of cement Ec that is assumed to be constant, having resistivity Rcem for various thicknesses and various resistivities of the layer of cement. The modeling was performed by finite element modeling on the assumption that Ifor is the depth derivative of the current flowing in the casing and calculating the current I(r,z) flowing in the disk defined by polar coordinates r, z.

The curves given in FIG. 4 show the simulated response of the tool assuming that the thickness of the central bed was 10 feet (3.04 m) and its resistivity Rt was 1 ohm-meter. The surrounding beds had resistivity Rsh of 100 ohm-meters, giving a contrast Rsh/Rt of 100 and the thickness of the layer of cement was 10 inches (23 cm) with cement having resistivity Rcem of 5 ohm.m.

It is clear that such a cement thickness is purely theoretical, with the thickness of the cement layer generally lying in the range about 1 cm to 4 cm. Nevertheless, such an overdimensioned thickness serves to illustrate the effect of the cement by amplifying it. It should also be observed that thicknesses of cement can be very much greater locally than the theoretical difference between the diameter of the bored hole as given by the size of the drill bit, and the diameter of the metal casing, since cavities (washouts) can form during drilling, e.g. when the well passes through poorly consolidated formations, and that this can lead to thicknesses of cement that are large, locally.

Tests have shown that the resistivity of cement in a well generally lies in the range 2 ohm.m to 5 ohm, such that the value used in the model is entirely realistic.

The response of the tool was calculated by adjusting the value of the factor k so that on going far enough away from the conductive layer (in the present case 9400 feet), the apparent resistivity should be equal to the resistivity Rsh of the surrounding bed. It can be seen in FIG. 4 that, as could be expected on examining FIG. 2, the presence of a layer of relatively resistive cement “masks” the conductive bed to some extent.

An entire series of simulations were then performed by varying the various parameters such as the resistivity of the central bed, of the lateral beds, and of the cement, and also the thickness of the layer of cement, thus making it possible to draw up various curves of the type shown in FIG. 5. In these curves, the open squares correspond to the ratio of cement resistivity over central bed resistivity Rcem/Rt being equal to 0.1; the solid circles represent Rcem/Rt=5, and the solid lozenges represent Rcem/Rt=10. The thickness of the cement is given in inches. The ordinate corresponds to the resistivity contrast between the lateral beds and the central bed (Rsh/Rt). Calculations were performed by assuming that Rt is equal to 1 ohm.m

FIG. 5 shows that for a ratio Rsh/Rt=10 and a thickness of 1½″, the apparent contrast Rsh/Rt measured by the tool will be 60 and not 100.

On the basis of the above model, curves are proposed for correcting the cement factor for use in methods according to the invention. A set of such curves is given in FIG. 6: given the value Rm as measured by the tool and given both the thickness and the resistivity of the layer of cement, the curves give the value of the correction equal to Rt/Rm by which the measured value Rm needs to be multiplied in order to obtain a “true” value.

The correction curves have been verified on a relatively complex well model as shown in FIG. 7. The selected formation model is given by the staircase curve (continuous black line). The dashed line curve corresponds to the response of the tool in the presence of a 1.5″ thick layer of cement whose effect is not corrected, while the chain-dotted line gives the response in the presence of the same layer of cement, but corrected using correction curves of the kind shown in FIG. 6. It can be seen that the correction is very good at low resistivities and rather less good at higher resistivities, particularly when the thicknesses of the beds are small (e.g. the bed centered on 8875). Nevertheless, it is important to observe that the tool is essentially intended for identifying zones of water ingress, i.e. zones of low resistivity, and that from this point of view, the method proposed by the invention is quite adequate.

FIG. 8 diagrammatically shows a system for implementing the above-described principle. The system comprises a sonde 12 suitable for being moved in an oil borehole provided with casing 11, and it is suspended from the end of an electrical cable 13 which connects it to surface equipment 14 comprising data acquisition and processing means and an electrical power supply 16. The sonde 12 is provided with three measurement electrodes a, b, and c which can be placed in contact with the casing, thereby defining casing sections (a,b) and (b,c) of length lying appropriately in the range 40 cm to 80 cm. In the embodiment shown, the electrodes a, b, and c are mounted on arms 17 hinged to the sonde 12. By means of mechanisms of known type that it is unnecessary to describe in detail herein, these arms may be swung out from the sonde so as to put the electrodes in contact with the casing, and then put back in the retracted position once the measurements have been finished. The electrodes are designed so that, once they are in contact with the casing, their positions remain as stationary as possible, and so that electrical contact with the casing is optimum

1. A method of determining the resistivity of a formation surrounding a borehole having a casing surrounded by a layer of cement located therebetween, comprising:
(i) injecting a current into the casing;
(ii) measuring current leaking from the casing into the formation;
(iii) determining the thickness of the layer of cement;
(iv) determining the conductivity of the layer of cement; and
(v) determining the resistivity of the formation using the measured current, the thickness of the cement, and the conductivity of the cement layer.

2. A method as claimed in claim 1, comprising determining the thickness of cement using data relating to drilling of the borehole and to the casing located therein:

3. A method as claimed in claim 1, comprising determining the conductivity of the cement layer from data obtained when preparing the cement for placement in the borehole.

4. A method as claimed in claim 1, comprising;
determining a series of correction curves for cement layers of different thicknesses, the correction curves relating the resistivity of the cement layer and the measured current; and
determining the resistivity of the formation using the correction curve most appropriate for the thickness and conductivity of cement.

5. A method as claimed in claim 4, wherein the correction curves comprise plots of the ratio of measured resistivity to cement resistivity vs. the ratio of true formation resistivity to measured resistivity for a series of cement thicknesses.

6. A method as claimed in claim 1, comprising measuring the resistivity of the formation at a number of depths in the well, comprising, at each depth:
(i) injecting a current into the casing;
(ii) measuring current leaking from the casing into the formation;
(iii) determining the thickness of the layer of cement;
(iv) determining the conductivity of the layer of cement; and
(v) determining the resistivity of the formation using the measured current, the thickness of the cement, and the conductivity of the cement layer.

7. A system for determining the resistivity of a formation surrounding a borehole having a casing surrounded by a layer of cement located therebetween, comprising:
a tool that can be positioned in the casing and including electrodes for injecting a current into the casing, and electrodes for measuring current leaking from the casing into the formation; and
an processing unit which determines the resistivity of the formation using the measured current, the thickness of the cement, and the conductivity of the cement layer.

8. A system as claimed in claim 7, wherein the tool is capable of being logged through the borehole so as to make measurements at a number of depths in the casing.

9. A system as claimed in claim 8, wherein the electrodes are urged against the casing as the tool is logged through the borehole.

10. A system as claimed in claim 7, wherein the processing unit it located at surface level and data is communicated between the tool and the processing unit.
